(19) United States
(12) Patent Application Publication
(10) Pub. No.: US 2025/0138161 A1
(43) Pub. Date: May 1, 2025

(54) SINGLE PHOTON AVALANCHE DIODES BASED TIME-OF-FLIGHT SENSOR FOR ELIMINATING BACKGROUND LIGHT AND METHOD THEREOF

(71) Applicant: DV2JS INNOVATION LLP, New Delhi (IN)

(72) Inventors: Mukul Sarkar, New Delhi (IN); Prabhleen Singh, New Delhi (IN); Rahul Singh, New Delhi (IN); Nitin Gupta, New Delhi (IN)

(21) Appl. No.: 18/923,098

(22) Filed: Oct. 22, 2024

(30) Foreign Application Priority Data
Oct. 26, 2023 (IN) 202311072990

(51) Int. Cl. G01S 7/481; G01S 7/4865; G01S 17/10

(52) U.S. Cl. CPC G01S 7/4816; G01S 7/4865; G01S 17/10

(57) ABSTRACT

The present invention relates to a single photon avalanche diodes-based time-of-flight sensor (100). The single photon avalanche diodes (SPADs) based time-of-flight (ToF) sensor (100) includes an Nx N single photon avalanche diode (SPAD) photodetector (101), a front-end (FE) unit (103), a pulse shaping (PS) unit (105), a pulse store unit (107), a peak detection unit (109), a digital logic unit (111), a timing processing circuitry unit (113), and memory elements unit (115). Due to integration of multiple units in single photon avalanche diodes (SPADs) based time-of-flight (ToF) sensor (100), the single photon avalanche diodes-based time-of-flight (ToF) sensor (100) accurately measures distance by adequate, suitable, and efficient elimination of background light.

### FIELD OF INVENTION

The present invention relates to a single photon avalanche diodes (SPAD) photodetectors that are employed in time-of-flight (ToF) sensors. Particularly, the present invention relates to a single photon avalanche diodes photodetectors-based time-of-flight sensor that provides an accurate distance measurement between an object and a target by eliminating background light.

### BACKGROUND OF INVENTION

With increase in demand of light detection and ranging applications (LiDAR) drive, development of Time-of-Flight (ToF) technique has been emphasized within electronics-based engineering industry. Generally, Time-of-Flight (ToF) sensors are used as measurement device to measure distance between sensor and object using light or electromagnetic waves. Due to this, ToF sensors are used for a range of applications, including robot navigation, vehicle monitoring, people counting, and object detection. Furthermore, ToF sensors utilizes ToF method for measuring distance between sensor and object, based on the time difference between the emission of a signal and its return to the sensor, after being reflected by the object. Conventionally, there are two main types of ToF sensors i.e. (a) optical and (b) electromagnetic. Optical ToF sensors uses light as source for measuring distance, while electromagnetic ToF sensors uses electromagnetic waves other than light. Both types of sensors operate on the same basic principle but varies on the method of measuring distance.

Optical ToF sensors uses a light pulse, typically in the near infrared (IR) range, as the source for distance measurement. The light pulse is emitted from the sensor and reflects off the object, returning to the sensor where it is detected. The time it takes for the light pulse to travel to the object and back is measured, and the distance between the sensor and the object is calculated using the speed of light.

Electromagnetic ToF sensors uses electromagnetic waves, such as microwave, ultrasonic, as the source for distance measurement. Like optical ToF sensors, the electromagnetic wave is emitted from the sensor and reflects off the object, returning to the sensor where it is detected. The elapsed time between the emission and detection of the electromagnetic wave is measured, and the distance between the sensor and the object is calculated based on the speed of electromagnetic wave.

ToF sensor have wide range of applications across various industries that are mentioned below:
ToF sensors can be used in robotics for obstacle detection and navigation;
ToF sensors can be used in driver-assist systems such as adaptive cruise control and collision avoidance systems;
ToF sensors are used in medical applications for non-invasive imaging and diagnostics;
ToF sensors are used in industrial automation for applications such as material handling, positioning, and quality control;
ToF sensors are used in drones and can be used to map crops and estimate yield, allowing for more crop management and reductions in chemical usage;
ToF sensors enable retailers to track customer movements, buying patterns and monitor inventory levels, allowing for more efficient and effective operations; and
ToF sensors are used for applications such as topographic mapping and land measurement.

In view of LiDAR technology, particularly with ToF sensors, there is a wide usage of single photon avalanche diodes (SPAD's) detectors and SPAD arrays. The SPAD photodetectors can measure single photons whose p-n junctions is reverse biased above its breakdown voltage such that a single photon incident on active device area can create an electron hole pair and thus trigger an avalanche of secondary carriers. The avalanche build-up time is typically on the order of picoseconds, so that the associated change in voltage can be used to precisely measure the time, of the photon arrival.

Several parameters are used to describe the performance of a single SPAD device. The most important is the photon detection probability (PDP), which represents the avalanche probability of the device in response to photon absorption at a given wavelength. In CMOS SPADs, the PDP has a peak in the visible region, which can reach 70% for single, optimised diodes. Other important parameters are the dark count rate (DCR), i.e. the observed avalanche rate in the absence of light, and after pulsing, which introduces false events that are correlated in time with previous detections.

Various other types of SPAD device are used to reduce the impact of background light such as Time-Correlated Single Photon Counting (TCSPC). It uses multiple optical signal shots and ToF measurements to generate a histogram. TCSPC method saturates when the average number of photons is greater than one. In this method, due to the timing electronics being sensitive to the first incoming photon, late arrival of photons are lost. So, the loss of photons decreases the efficiency as well as distorts the histogram resulting in reduced accuracy.

Further, in high ambient light environment, to determine ToF, a multi-hit time to digital converter (TDC) along with TCSPC is used but it requires memory to store both true and false ToF. The memory requirement increases the area constraint. Additionally, in another method, background light can be eliminated using optical filters. However, the use of optical filters cannot help in very high ambient light. Another technique known as time gating allows the SPADs to be sensitive only during specific time windows. The method processes the optical signal by filtering the noise photons not detected in the given time window. It is difficult to accurately determine the timing window's position to pass desired optical signals for detection. It requires continuous modulation of time gating position thus requires manual intervention. Further, it reduces the overall readout time or frame rate.

Also, coincidence detection is a prominently used method to reduce background light's impact. It exploits the random properties of incident background light photons exhibiting disparate arrival times. The ToF is obtained only when a cluster of SPADs detect a certain threshold of photons. The method requires either a fixed or adaptive thresholding. Both the thresholding requirements do suffer in the automotive environments where background light and targets' reflectivity change dynamically.

In furtherance of this, it has been observed and noticed that when ToF sensors utilizes SPAD detectors, they suffer from ambient light and thermal effects. Such ambient light and thermal effects cause background charge generation in SPADs detectors. These background charge/light causes noise generation which hampers resultant image quality. Alternatively, such background charge causes flux of noise while measuring distance between sensor and object. Thus, causing erroneous distance measurement and may fail the very objective of ToF sensors.

Various prior arts exist in reference to single photon avalanche diodes (SPAD) detectors that are primarily used in CMOS image sensor, especially in ToF sensors that are mentioned herein-below:
KR102471540 teaches and discloses a method for subtracting background light from an exposure value of a pixel in an imaging array and a pixel using the same, wherein the first pixel receives a reflection of a spot from a scene illuminated by a periodically pulsed pattern of spots. The periodically pulsed pattern includes alternating illuminated and non-illuminated phases. The method comprising: detecting the spot for a predetermined amount of time while detecting the spot; accumulating in the first pixel a charge proportional to a first amount of incident light received by the pixel; and in the absence of the spot, reducing a charge proportional to a second amount of incident light received for the predetermined amount of time.

Furthermore, KR'540 teaches and discloses a system for determining a distance to an object that comprises of a solid-state light source arranged to project a pattern of spots of laser light toward the object in a sequence of pulses;
a detector comprising the imaging array described above, the detector configured to detect light representing a pattern of spots reflected by the object in synchronization with the sequence of pulses; and
processing means configured to calculate a distance to the object as a function of an exposure value produced by the pixels in response to the detected light,
wherein the pixels are configured for each pulse in the sequence and accumulates a first amount of charge representing a first amount of light reflected by the object during a first predetermined time window and a second amount of charge reflected by the object during a second predetermined time window and generate the exposure value by accumulating a second amount of charge representative of an amount of light, wherein the second predetermined time window occurs after the first predetermined time window.

U.S. Pat. No. 10,397,554 teaches and discloses a time-of-flight three-dimensional imaging system that includes imaging module coupled with a processor, single photon avalanche diode (SPAD) core portion memory module, projector module, image sensor unit, laser light source, laser controller, projection optics, and focusing lens. Furthermore, US'554 teaches and discloses the image sensor, comprising:
a first type of diodes that each detect one or more incident photons; and
a time-resolving sensor that outputs a first reset signal, a second reset signal, a first measurement signal and a second measurement signal, the first reset signal representing a reset-charge level of a first floating diffusion and the second reset signal representing a reset-charge level of a second floating diffusion, the first reset signal and the second reset signal being output in response to a reset condition.

US20220170784 teaches and discloses a system for photon correlation of an illuminated object and/or a light source, comprising:
a light source for illuminating the object or to correlate;
an optical system having an object-facing side configured to face the object or the light source and a projection side, the projection side having a focal plane;
a single-chip single photon avalanche photodiode (SPAD) array arranged at the focal plane; and
a timing circuit associated with the single-chip SPAD array for measuring arrival times of photons detected by the single-chip SPAD array.

Furthermore, US'784 teaches and discloses a method for characterizing cross-talk probabilities with a system for photon correlation. The system including,
a classical or pseudo-thermal light source for illuminating the object or to correlate,
an optical system having an object-facing side configured to face the object or the light source and a projection side, the projection side having a focal plane,
a single-chip single photon avalanche photodiode (SPAD) array arranged at the focal plane, and
a timing circuit associated with the single-chip SPAD array for measuring arrival times of photons detected by the single-chip SPAD array.

Further, it discloses a method for characterizing cross-talk probabilities with a system for photon correlation which includes:
analyzing photon correlations from the classical or pseudo-thermal light source using the above system.

CN112129406 teaches and discloses a single photon detector array and the system with high detection efficiency and crosstalk suppression function that comprises of a bias voltage source, a single photon detector array, an active quenching circuit chip, a crosstalk identification and suppression circuit, a signal processing system, and a light source.

Furthermore, CN'406 discloses a method of cross talk suppression by utilizing single photon detector array system wherein the bias voltage source outputs controllable direct current voltage to all single photon avalanche photodiodes in the single photon detector array, and provides bias voltage required by a single photon working mode for the single photon avalanche photodiodes.

However, it has been observed that, conventional image sensor having single photon avalanche diodes (SPAD) photodetectors suffers from a limitation wherein background light removal is a complex, time-taking process. Further, large memory/data storage system is required in conventional image sensor having SPAD photodetectors that makes image sensor area and computational heavy. Due to this, manufacturing cost for producing such image sensor with SPAD photodetector is quite high.

In view of limitation associated with conventional image sensor with SPAD photodetector, there requires a technical solution to mitigate such issues. Thus, present invention achieves objective of providing a single photon avalanche diodes-based time-of-flight sensor that provides high control over background light for measuring distance accurately.

### SUMMARY OF THE INVENTION

There is a need for a more effective, competent, efficient, compact, economical, simple, easy to operate and a high dynamic range ToF sensor that uses single photon avalanche diodes (SPADs) for accurately measuring distance between an object and a target.

The present invention relates to a single photon avalanche diodes (SPADs) based time-of-flight (ToF) sensor that eliminates background light which includes:
a plurality of single photon avalanche diodes (SPAD) photodetectors unit configured to detect a plurality of photons to trigger self-sustaining avalanche current/photons;
a plurality of front-end unit that receive avalanche photons from the single photon avalanche diodes and is configured to provide quenching and re-charging of the single photon avalanche diodes photodetectors;
a plurality of pulse shaping unit that receives pulse from the front-end unit and is configured to provide a defined pulse width to the received pulse;
a plurality of pulse store unit that receives defined pulse width from the pulse shaping unit and is configured to provide storing plurality of pulse of incoming single photon avalanche diodes events;
a plurality of peak detection unit that receives pulse width from the pulse shaping unit and is configured to sense coincidence/peak among the defined pulse width;
a plurality of digital logic unit that receives output from pulse store unit and peak detection unit and is configured to perform pre-defined logical operations to the received input;
a plurality of timing processing circuitry unit that receives output from the digital logic unit and is configured to perform calculation of timing onto output received from the digital logic unit; and
a plurality of memory element unit that receives and stores output from timing processing circuitry for providing analysis on characteristics of incident photons
wherein the single photon avalanche diodes-based time-of-flight (ToF) sensor accurately measures distance by adequate, suitable, and efficient elimination of background light.

The present invention also relates to a background light removal/elimination method employed in single photon avalanche diodes (SPAD) based time-of-flight (ToF) sensor for measuring distance accurately. The method includes steps:
detecting photons and triggering detected photons to produce avalanche current/photons using a single photon diode (SPAD) photodetector;
next, quenching and re-charging SPAD photodetector, wherein avalanche photons is provided to front-end unit;
thereafter, providing a defined pulse width to pulse shaping unit from the front-end unit;
thereafter, sharing the output of pulse shaping unit shares in two instances:
   in first instance, the pulse width is stored in pulse store unit; and
   in second instance, peak of pulse is detected using coincidence technique and then sensed the coincidence among incoming pulse shaping unit in peak detection unit;
next, performing pre-defined logical operations onto peak detected output by utilizing digital logic unit;
then, performing calculation of timing onto peak detected signal by utilizing timing processing circuitry; and
lastly, storing timing-based signal in memory unit for analysing characteristics of photons as incident onto single photon avalanche diodes.

The single photon avalanche diodes based ToF sensor of present invention accurately measure distance, especially in presence of high background light and different target reflectivity. Furthermore, single photon avalanche diodes based ToF sensor generate unique time-of-flight information per optical signal pulse period for each SPAD participating concurrently with other SPADs in a cluster. Due to this, there is an enhanced signal to background noise which thereby resolves low and high reflectivity targets. Thereby, allowing an increase in the dynamic range of the direct time of flight light detection and ranging.

This summary is not intended to limit the key essential features of the present invention nor its scope and application. Other advantages and details about the system and the method will become more apparent to a person skilled in the art from the below detailed description of the invention when read in conjugation with the drawings.

### BRIEF DESCRIPTION OF THE ACCOMPANYING DRAWINGS

FIG. 1(a) illustrates and represents an in-pixel background light rejection circuitry having single photon avalanche diodes-based time-of-flight sensor for elimination of background light in accordance with an embodiment of the present invention.

FIG. 1(b) illustrates and represents a 2×2 temporally correlated pixel circuit utilized in single photon avalanche diodes-based time-of-flight sensor in accordance with an embodiment of the present invention.

FIG. 2 illustrates and represents background light removal/elimination method employed in single photon avalanche diodes (SPAD) based time-of-flight (ToF) sensor in accordance with an embodiment of present invention.

FIG. 3 illustrates and represents an operational timing diagram resulting from the single photon avalanche diodes-based time-of-flight sensor in accordance with the present invention.

The present invention can be understood with reference to the detailed figures and description set forth herein. Various embodiments are discussed below with reference to the figures. However, those skilled in the art will readily appreciate that the detailed descriptions given herein with respect to the figures are simply for an explanation of the invention as the methods and products may extend beyond the described embodiments. For example, the teachings presented and the needs of a particular application yield multiple alternatives and suitable approaches to implement the functionality of any detail described herein. Therefore, any approach extends beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, circuit, architecture, characteristic, property, element, or limitation but that not every embodiment or example necessarily includes that particular feature, circuit, architecture, structure, characteristic, property, element, or limitation. Further, repeated use of the phrase “in an embodiment” does not necessarily refer to the same embodiment.

### DESCRIPTION

Thus, present invention is devised that overcomes limitations as associated with conventional single photon avalanche diodes-based time-of-flight sensor.

The present invention relates to a single photon avalanche diodes (SPADs) based time-of-flight (ToF) sensor that eliminates background light which includes:
a plurality of single photon avalanche diodes (SPAD) photodetectors unit configured to detect a plurality of photons to trigger self-sustaining avalanche current/photons;
a plurality of front-end unit that receive avalanche photons from the single photon avalanche diodes and is configured to provide quenching and re-charging of the single photon avalanche diodes photodetectors;
a plurality of pulse shaping unit that receives pulse from the front-end unit and is configured to provide a defined pulse width to the received pulse;
a plurality of pulse store unit that receives defined pulse width from the pulse shaping unit and is configured to provide storing plurality of pulse of incoming single photon avalanche diodes events;
a plurality of peak detection unit that receives pulse width from the pulse shaping unit and is configured to sense coincidence/peak among the defined pulse width;
a plurality of digital logic unit that receives output from the pulse store unit and peak detection unit and is configured to perform pre-defined logical operations on the received input;
a plurality of timing processing circuitry unit that receives output from the digital logic unit and is configured to perform calculation of timing onto output received from the digital logic unit; and
a plurality of memory element unit that receives and is configured to store output from timing processing circuitry for providing analysis on characteristics of photons
wherein the single photon avalanche diodes-based time-of-flight (ToF) sensor accurately measures distance by adequate, suitable, and efficient elimination of background light.

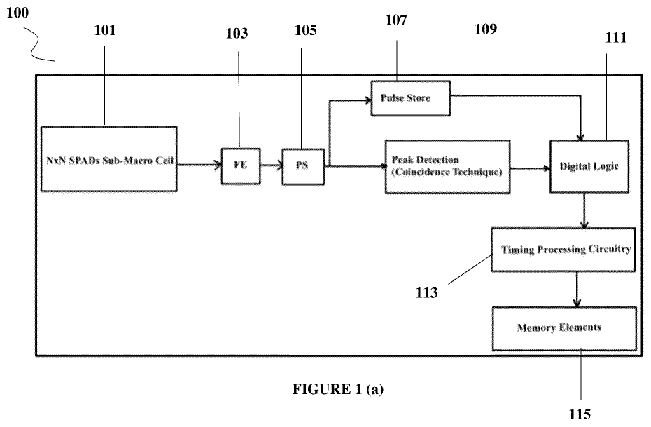

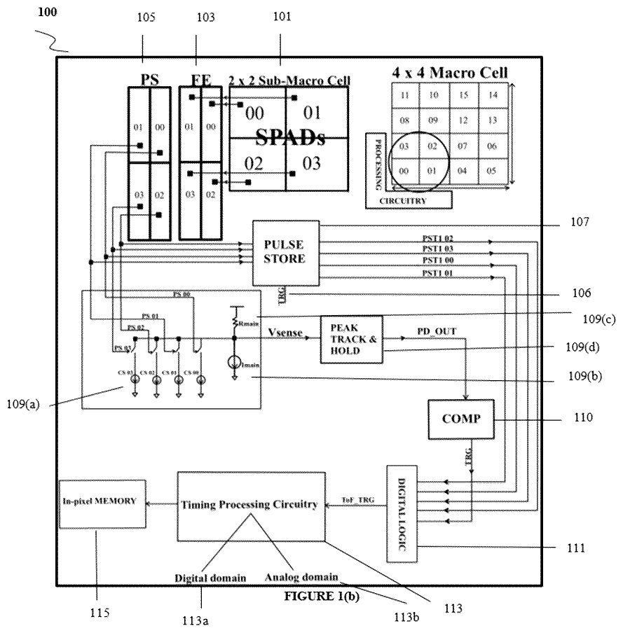

FIG. 1(a) illustrates and represents a single photon avalanche diodes-based time-of-flight sensor for elimination of background light in accordance with an embodiment of the present invention. It illustrates a single photon avalanche diodes (SPADs) based time-of-flight (ToF) sensor with an in-pixel background light rejection circuitry (100) according to an example embodiment. The single photon avalanche diodes (SPADs) based time-of-flight (ToF) sensor (100) includes an N×N single photon avalanche diode (SPAD) photodetector (101), a front-end (FE) unit (103), a pulse shaping (PS) unit (105), a pulse store unit (107), a peak detection unit (109), a digital logic unit (111), a timing processing circuitry unit (113), and memory elements unit (115). Furthermore, time-of-flight sensors majorly utilizes SPAD photodetector, but, alternatively different types of photodetectors may be utilized for carrying out elimination of background light.

The single photon avalanche diodes (SPADs) based time-of-flight (ToF) sensor (100) with in-pixel background light rejection circuitry (100) is designed for smaller group of SPADs from (N×N) SPADs photodetector (101). (N×N) SPADs have one background light rejection and decision circuitry. Upon detecting at least one photon, SPAD triggers an avalanche.

So, in present invention, SPAD photodetectors (101) is in array form with a defined sub-macro-cell that is according to the requirement and purpose for which time-of-flight sensors (ToF) is utilized. The SPAD photodetectors array operate with a relatively high reverse voltage. At this bias, the electric field is so high that a single charge carrier injected in the depletion layer can trigger a self-sustaining avalanche. Due to this, such SPAD photodetectors can detect low intensity signals and to signal the time of the photon arrival with high temporal resolution. The avalanche current/photons as obtained through SPAD photodetectors (101) are provided to the front-end unit (103) i.e. each SPAD has its own front-end (FE) unit (103) which quenches and recharges the SPAD.

The front-end unit (103) forms an intricate part as they are configured to provide quenching and recharging of photodetectors. In furtherance of this, front-end unit (103) is equipped with different types of quenching circuits that includes passive, active, mixed passive and active as well as gated modes. They are used and designed in such way to stop rapid increasing of avalanche current and is achieved by decreasing the over-bias voltage. The ideal front-end (FE) unit (103) would lower the voltage applied to the device as soon as a photon has been detected, then wait for the avalanche current to diminish to insignificant level before restoring the over-bias to the device. The avalanche current is quenched as soon as it begins to flow, so the number of carriers travelling through the SPAD is low, which in turn limits after-pulsing. This would lead to a short hold-off time, maximising the SPAD's maximum operation frequency.

The front-end unit output is provided/transmitted to the pulse shaping (PS) unit (105) i.e. FE units are followed by their respective PS units. The pulse shaping (PS) unit (105) provides a filtering technique that shapes waveform/pulses of signal in defined form which is required as per functionality of single photon avalanche diodes-based time-of-flight sensor (100). Further, pulse width as obtained through pulse shaping unit (103) is in such form and shape that is supported by other units such as pulse store unit (107), peak detection unit (109), digital logic unit (111), timing processing circuitry unit (113), and memory elements unit (115). Thus, PS unit (105) shapes the pulse-width of the FE output.

The pulse width/defined pulse obtained via pulse shaping (PS) unit (105) is provided to two units:
i. in first instance the pulse shaping (PS) unit (105) shares its output to Pulse store unit (107), wherein pulse width/defined pulse is stored for a pre-defined amount of time. The pre-defined amount of time is calculated in reference to functionality for which single photon avalanche diodes-based time-of-flight sensor (100) is to be used for. Thus, pulse store unit (107) stores the pulses of incoming SPAD events;
ii. in second instance the pulse shaping (PS) unit (105) shares its output to the peak detection unit (109). Peak detection unit (109) senses the coincidence among incoming PS output pulses. It generates a trigger signal every time higher number of coincidence occurs. In contrast to sensing and putting a constant threshold for the number of coincident events, this work detects the peak coincidence.

So, the functionality of the peak detection unit (109) is based on coincidence technique, wherein signal peak is detected from reflected light. Furthermore, signal peak detected via peak detection unit (109) represents highest number of coincident (temporally correlated) photons. In other words, peak detection unit (109) takes advantage of SPAD detectors (101) spatial closeness by rejecting influence of background light, wherein background light has a characteristic of being uncorrelated in time. This also implies exploiting random properties of incident background light photons exhibiting disparate arrival time.

Peak detected signal is used as an input to the digital logic unit (111), wherein digital logic unit (111) uses application of pre-defined logical gates. Further, functionality of digital logic unit (111) is to perform logical operations, wherein ensuring that only correlated time signal is used/filtered/passed in single photon avalanche diodes-based time-of-flight sensor (100).

Logic output from the digital logic unit (111) is passed as an input to the timing processing circuitry unit (113). So, peak detection unit (109) passes the trigger signal to the timing processing circuitry (113) through digital logic unit (111).

This timing processing circuitry unit (113) is configured to perform calculation of time in reference of logic signal as obtained via digital logic unit (111). Timing processing circuitry unit (113) performs the calculation of ToF of each SPAD that participated in generating the trigger signal. The measured ToF is latched to the in-pixel memories.

Further, timing processing circuitry unit (113) comprises of clock signals, wherein the clock signal oscillates between high and low state. Due to this, such circuitry unit (113) synchronizes the processing logic/its sequence of actions. It is because of timing processing circuitry unit (113) that the timing of correlated time signals is kept in such way or signal are processed in such manner that there is an elimination of crosstalk among plurality of signals. Thereby, eliminating chances of distortion of signal and improving picture/image quality as obtained via SPADs based time of flight sensor (100).

The memory element unit (115) receive signals from timing processing circuitry unit (113). It is configured to provide storage of signals and thereby providing pixel information for analysis of resultant image. The stored data in the memory is used to measure the distance between an object and a target.

Thus, the single photon avalanche diodes (SPADs) based time-of-flight (ToF) sensor (100) improves the accuracy of the measured distance by rejecting the background light. It uses an in-pixel background rejection technique in spatially closed SPADs. It takes advantage of SPAD detector's spatial closeness and resolves the temporal proximity of the optical signal photons (coincident photons). It rejects the influence of the background light (uncorrelated in time) by exploiting the random properties of incident background light photons exhibiting disparate arrival times. This method filters the optical signal from the background light photons by detecting the peak of the reflected light.

The signal peak represents the highest number of coincident (temporally correlated) photons. The signal peak triggers the timing processing circuitry (113). It generates the ToF of each spatially closed SPAD which participated in coincidence detection. Preserving the ToF information of such SPADs provides a more granular point cloud information of the scene. The technique offers unique ToF information per optical signal pulse period. It provides ToF and generates intensity images depending on the mode chosen during the programming of the sensor.

Further, FIG. 1(b) illustrates and represents a 2×2 temporally correlated single photon avalanche diodes-based time-of-flight sensor in accordance with an embodiment of the present invention. The 2×2 temporally correlated pixel circuit includes 2*2 sub-macro cell SPAD photodetector array 101 i.e. 00, 01, 02, and 03. In furtherance of this, a SPAD photodetector array is connected to 2*2 macro-cell of front-end (FE) unit (103), wherein macro-cell is represented as 00, 01, 02, and 03. The SPAD photodetectors receive electrons/photo detected photons and generates avalanche photons. The avalanched electrons are processed by front-end unit. Further, front unit is configured to provide quenching and recharging of SPAD photodetectors.

The quenched output from front-end unit (103) is provided to the pulse shaping (PS) unit (105), wherein defined shape is provided to pulse to generate pulse width. In one of the embodiments, pulse shape unit (105) is comprised of 2*2 macro-cell i.e. 00, 01, 02, and 03, wherein pulse width of defined form is generated i.e. PS 00, PS 01, PS 02, and PS 03.

The defined pulse width PS 00, PS 01, PS 02, and PS 03 is provided as an input to the pulse store unit (107). The stored pulse is numbered as PST00, PST01, PST02, and PST 03. In furtherance of this, pulse store unit (107) is provided with triggered signal TRG (106) which provides an analysis for signals that must be processed for peak detection by using the peak detection unit (109).

The peak detection unit (109) includes controlled current sinks CS 00, CS 01, CS 02, and CS 03 [109a], current sensing unit 109(b), resistor 109(c), and peak track and hold circuit 109(d). The current sinks 109(a) provides an adjustable/regulation voltage to the pulse width signal and it also influence how pulse shaping happens. Then, current sensing block 109(b) and resistor 109(c) are utilized. These units ensure adequate measuring of voltage onto signal that have undergone regulation of current. These units provide voltage of defined value and is represented as Vsense. The output voltage Vsense is provided as an input to the peak track and hold circuit 109(d). In this, defined voltage Vsense is held for a pre-defined time and is used for tracking of peak. In this, peak detection process Vsense is tracked in reference to threshold voltage Vthreshold, further, if Vsense>Vthreshold, the, Vsense is processed for further operations. This ensures that correlated time based signal is tracked adequately, suitable, and efficiently so that there occurs no instance of uncorrelated time-based signal. The uncorrelated time based signal is a characteristics of background light that occurs randomly and has disparate arrival of time.

Further, the output from peak track and hold unit 109(d) i.e. PD_OUT is provided to a comparator COMP (110). The COMP is used for configuring comparison among the signals to determine peaked signal. Alternatively, COMP (110) is configured to decide if new peaked signal is greater than previous held peak. This ensures that new peak signal has adequate elimination of background light that causes disruption while measuring distance from SPAD based time-of-flight sensor (100). The output from COMP (110) is a triggered signal TRG which is further provided as an input to the digital logic unit (111).

The output from digital logic unit (111) i.e. time-of-flight triggered signal ToF_TRG is passed onto the timing processing circuitry (113). The timing processing circuitry (113) provides output in digital domain 113 (a) and analog domain 113 (b) and is configured to process timing on logical signal such that there occurs no cross-talk among the signals.

Output from the timing processing circuitry (113) is provided as an input to the memory elements unit (115) and is configured to store processed time signal that is free of crosstalk. This also provided an in-depth analysis of signals as utilized by SPAD based time-of-flight sensors that does not include background light.

As a result, the present invention exploits the technique of coincidence detection by not relying on correlated photon number thresholding. It works in breakdown mode and woks even if there is a single photon and provide a better result wherein output is digital in nature. Further, it does not completely rely on the histogramming approach and requirement of significant memory elements is low.

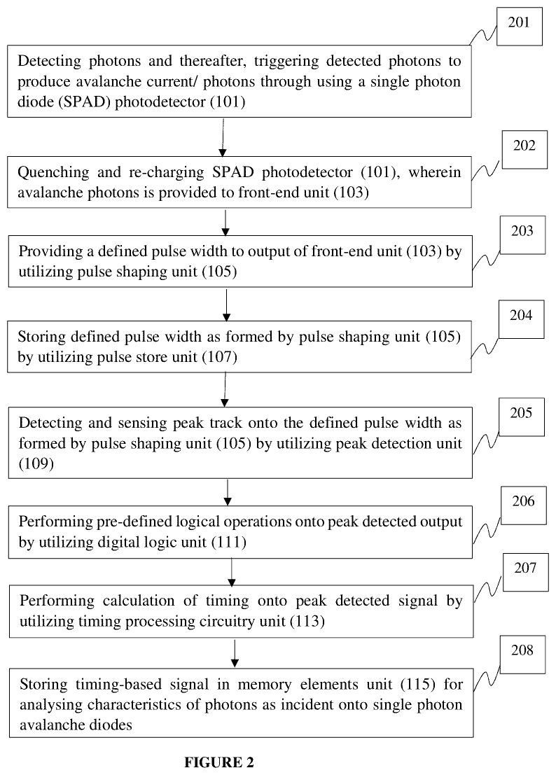

FIG. 2 illustrates and represents background light removal/elimination method employed in single photon avalanche diodes (SPAD) based time-of-flight (ToF) sensor (100) in accordance with an embodiment of present invention. The method includes following sequence of steps:
at step 201, detecting plurality of photons when a pre-determined frequency of light falls for a defined amount of time onto SPAD photodetector (101). The SPAD photodetectors (101) thereby causes generation of avalanche current/photons as they are a reverse biased diode with biasing voltage greater than breakdown voltage;
then, at step 202, quenching and recharging SPAD photodetectors unit (101) by utilizing front-end unit (103). This happens because avalanche current/photons are provided as an input to the front-end unit (103) from SPAD photodetectors (101). The front-end unit (103) forms an intricate unit for SPAD based time of flight sensor (100) as it ensures inhibition towards rapid increasing of avalanche current. Due to this, SPAD photodetectors are made sure that they are not over-heated which may lead to their non-working/non-usability for next operations;
next, at step 203, providing a defined shape to the signal/output provided by front-end unit (103). Due to this, there is generation of defined pulse width from pulse shape unit (105). The pulse shaping is done in such way that it is adaptable or supported by other units such as pulse store unit (107), peak detection unit (109), digital logic unit (111), timing processing circuitry (113), and memory elements unit (115);
then, at step 204, storing of pulse width as obtained via pulse store unit (107), wherein such pulse storing operation is performed by pulse store unit (107);
next, at step 205, detection of peak into pulse width signal, wherein operation of detection is performed via peak detection unit (109). The peak detection unit (109) is integrated with components that includes controlled current sinks CS 00, CS 01, CS 02, and CS 03 [109a], current sensing block 109(b), resistor 109(c), and peak track and hold circuit 109(d). Further, peak detection unit (109), provides defined peak to the pulse width signal only when Vsense is greater than Vthreshold [Vsense>Vthreshold]. This ensures that correlated time-based signal is tracked adequately, suitably, and efficiently so that there occurs no instance of uncorrelated time based signal. The uncorrelated time-based signal is a characteristics of background light that occurs randomly and has disparate arrival of time;
then, at step 206, providing peak detected signal as well as stored pulse width signal from peak detection unit (109) and pulse store unit (107) respectively to the digital logic unit (111). The digital logic unit (111) performs operation of utilizing plurality of different combination of logical gates to ensure that only correlated time based signal is processed through SPAD based time of flight sensor (100) to ensure adequate elimination of background light;
then, at step 207, receiving logical-based output provided by digital logic unit (11) into the timing processing circuitry (113). Further, timing processing circuitry comprises of a clock signals, wherein the clock signal oscillates between high and low state and synchronizes the processing logic. Due to this, such circuitry unit (113) follows in time to coordinate its sequence of actions. It is because of timing processing circuitry (113) the timing of correlated time signals is kept in such way or signal are processed in such manner that there is an elimination of crosstalk among plurality of signals. Thereby, eliminating chances of distortion of signal and improving picture/image quality as obtained via SPAD based time of flight sensor (100).
lastly, at step 208, storing signal as obtained in memory elements units (115) from timing processing circuitry (113). This unit provides an analysis factor wherein SPAD based time of flight sensors analyzes signal characteristics in order to provide an adequate elimination of background light. Due to this, there is an accuracy maintained while measuring distance between an object and a target.

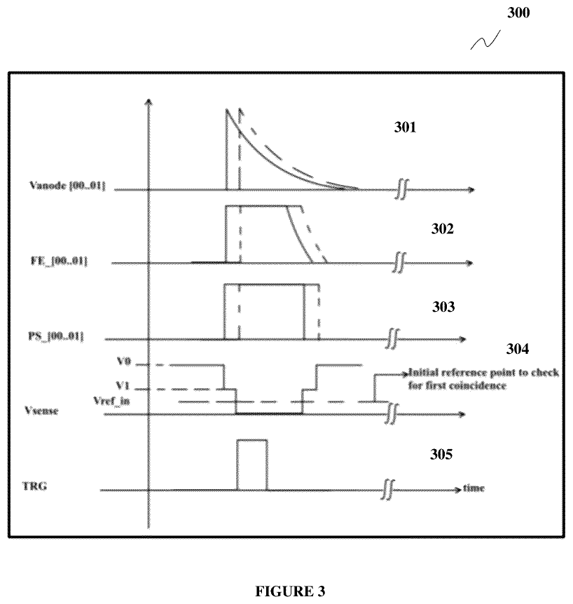

FIG. 3 illustrates and represents an operational timing diagram resulting from the single photon avalanche diodes-based time-of-flight sensor in accordance with an embodiment of the present invention. The operational timing diagram as plotted in FIG. 3 represents X and Y axis, wherein X axis represents voltage value of a signal and Y axis represents timing in reference to voltage.

The operational timing diagram (300) represents a sudden peak of current (301) that is obtained due to generation of avalanche current/photons provided by utilizing SPAD photodetectors (101) in the SPAD based time of flight sensor (100) used for adequate elimination of background light. The dashed line as shown in 301 represents similar obtained operating timing provided by other SPAD photodetectors as are arranged in SPAD photodetectors array.

The graph 302 of operation timing diagram provides evidence towards reduction of rapid increase of avalanche current to ensure that SPAD photodetectors does not get over-heated which may cause it to be un-operational. Further, it shows that at what point, front-end unit (103) is used in SPAD based time of flight sensor (100).

The graph 303 represents pulse width of defined shape/width wherein quenched signal obtained via pule shape unit (105), wherein input is provided via front-end unit (103).

The graph 304 represents plot of voltage in reference to time that is obtained in reference to Vsense. The plot represents stepped voltage that is obtained via determining peak onto a pulse width signal. This peak is detected via utilizing peak detection unit (109).

The graph 305 represents plot of graph that is obtained for triggered signal (TG) wherein a peak is illustrated. The triggered signal (TRG) represents highest number of coincident photons or correlated time-based signal as obtained via SPAD based time of flight sensor (100).

Thus, the single photon avalanche diodes-based time-of-flight sensor of present invention provides an enhanced accuracy of the measured distance in the presence of high background light and different target reflectivity. Further, single photon avalanche diodes-based time-of-flight sensor generate unique time-of-flight information per optical signal pulse period for each SPAD participating concurrently with other SPADs in a cluster.

Present invention also provides a perseverance of SPADs spatial closeness and provide a granular point cloud information of the scene. Additionally, the present single photon avalanche diodes-based time-of-flight sensor improves frame rate of sensor by generating only one time-of-flight per optical signal pulse period. Due to this, there is an enhanced signal to background ratio. Thereby, single photon avalanche diodes-based time-of-flight sensor provides resolving of low and high reflectivity targets, allowing an increase in the dynamic range of the direct time-of-flight light detection, and ranging (LiDAR).

Further, the advantages of present invention are as follows:
To enhance the accuracy of the measured distance in the presence of high background light and different target reflectivity using an in-pixel background rejection algorithm.
To generate unique ToF information per optical signal pulse period for each SPAD participating concurrently with other SPADs in a cluster.
To preserve the SPADs' spatial closeness and provide a more granular point cloud information of the scene.
To improve the frame rate of the sensor by generating only one ToF per optical signal pulse period.
To enhance the Signal-to-Background Ratio (SBR).
To resolve low and high reflectivity targets, allowing an increase in the dynamic range of the direct time-of-flight (dToF) Light Detection and Ranging (LiDAR).
To provide programmability of SPADs' cluster size, which can help capture more coincident events in the presence of very strong background light.
To remove the dependency of coincidence threshold.
Simplify instrumentation for histogram generation and peak detection.

Thus, the present in-pixel circuit utilized in single photon avalanche diodes-based time-of-flight sensor improves the accuracy of the measured distance by rejecting the background light. It uses an in-pixel background rejection technique in spatially closed SPADs. It takes advantage of the SPAD detector's spatial closeness and resolves the temporal proximity of the optical signal photons (coincident photons). It rejects the influence of background light (uncorrelated in time) by exploiting the random properties of incident background light photons exhibiting disparate arrival times. The method filters the optical signal from the background light photons by detecting the peak of the reflected light.

The signal peak represents the highest number of coincident (temporally correlated) photons. The signal peak triggers the timing processing circuitry. It generates the ToF of each spatially closed SPAD which participated in coincidence detection. Preserving the ToF information of such SPADs provides a more granular point cloud information of the scene. The technique offers unique ToF information per optical signal pulse period. The present invention provides ToF and generates intensity images depending on the mode chosen during the programming of the sensor.

As a result, it provides a more effective, competent, efficient, compact, economical, simple, easy to operate and a high dynamic range ToF sensor that uses single photon avalanche diodes (SPADs) for accurately measuring distance between an object and a target.

A description of an embodiment with several electronic components, and comparators are mentioned, wherein such components and comparators are arranged in a circuit as herewith described. While such electronic components as listed in description do not act as limitation for incorporation of other electronic components. On the contrary, a wide variety of other useful, adequate, easily available electronic components of different characteristics and types can be employed in a CMOS image sensor circuit for producing a better image quality.

While the present disclosure has been described with reference to certain embodiments and exemplary embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope.

We claim:

1. A single photon avalanche diodes (SPADs) based time-of-flight (ToF) sensor (100) that accurately measures distance by adequate, suitable, and efficient elimination of background light comprises:
a plurality of N×N SPAD photodetectors unit (101), to detect a plurality of photons to trigger self-sustaining avalanche current/photons;
a plurality of front-end unit (103), to receive avalanche photons from the N×N SPAD photodetectors unit (101) to quench and re-charge the N×N SPAD photodetectors unit (101);
a plurality of pulse shaping unit (105), to receive pulse from the front-end unit (103) and to provide a defined pulse width to the received pulse;
a plurality of pulse store unit (107), to receive defined pulse width from the pulse shaping unit (105) and to store a plurality of pulse of incoming single photon avalanche diodes events;
a plurality of peak detection unit (109), to receive pulse width from the pulse shaping unit (105) and to sense coincidence/peak among the defined pulse width;
a plurality of digital logic unit (111), to receive output from the pulse store unit (107) and peak detection unit (109) and to perform pre-defined logical operations on the received input;
a plurality of timing processing circuitry unit (113), to receive output from the digital logic unit (111) and to perform calculation of timing onto output received from the digital logic unit (111); and
a plurality of memory element unit (115), to receive and store output from timing processing circuitry unit (113) to provide analysis on characteristics of incident photons.

2. The SPADs based time-of-flight (ToF) sensor (100) that accurately measures distance by adequate, suitable, and efficient elimination of background light as claimed in claim 1, wherein the N×N SPAD photodetectors unit (101) is a reverse biased diode with biasing voltage greater than breakdown voltage (Vthreshold).

3. The SPADs based time-of-flight (ToF) sensor (100) that accurately measures distance by adequate, suitable, and efficient elimination of background light as claimed in claim 1, wherein the N×N SPAD photodetectors unit (101) generates avalanche current/photons.

4. The SPADs based time-of-flight (ToF) sensor (100) that accurately measures distance by adequate, suitable, and efficient elimination of background light as claimed in claim 1, wherein the N×N SPAD photodetectors unit (101) generates unique time-of-flight information per optical signal pulse period for each SPAD participating concurrently with other SPADs in a cluster.

5. The SPADs based time-of-flight (ToF) sensor (100) that accurately measures distance by adequate, suitable, and efficient elimination of background light as claimed in claim 1, wherein the pulse width/defined pulse obtained via pulse shaping unit (105) is provided to two units:
in first instance, the pulse width/defined pulse is stored in the pulse store unit (107); and
in second instance, the pulse width/defined pulse is shared to the peak detection unit (109) to generate a trigger signal.

6. The SPADs based time-of-flight (ToF) sensor (100) that accurately measures distance by adequate, suitable, and efficient elimination of background light as claimed in claim 5, wherein pulse width/defined pulse is stored for a pre-defined amount of time, calculated in reference to functionality for which SPADs based time-of-flight (ToF) sensor (100) is to be used for.

7. The SPADs based time-of-flight (ToF) sensor (100) that accurately measures distance by adequate, suitable, and efficient elimination of background light as claimed in claim 5, wherein the trigger signal is generated based on coincidence among incoming pulse shaping output pulses sensed by peak detection unit (109).

8. The SPADs based time-of-flight (ToF) sensor (100) that accurately measures distance by adequate, suitable, and efficient elimination of background light as claimed in claim 1, wherein the peak detection unit (109) comprises:
a plurality of controlled current sinks CS 00, CS 01, CS 02, and CS 03 [109a], to provide an adjustable/regulation voltage to the pulse width signal and to influence how pulse shaping occurs;
a plurality of current sensing unit 109(b);
a plurality of resistor 109(c); and
a plurality of peak track and hold circuit 109(d), to hold a defined voltage, Vsense for a pre-defined time and for tracking of peak.

9. The SPADs based time-of-flight (ToF) sensor (100) that accurately measures distance by adequate, suitable, and efficient elimination of background light as claimed in claim 8, wherein the current sensing unit 109(b) and the resistor 109(c) measure the voltage onto signal of defined value represented as Vsense.

10. The SPADs based time-of-flight (ToF) sensor (100) that accurately measures distance by adequate, suitable, and efficient elimination of background light as claimed in claim 1, wherein the digital logic unit (111) allows only correlated time signal to be used/filtered/passed.

11. The SPADs based time-of-flight (ToF) sensor (100) that accurately measures distance by adequate, suitable, and efficient elimination of background light as claimed in claim 1, wherein the timing processing circuitry unit (113) comprises of clock signal which oscillates between high and low state and synchronizes the processing logic.

12. The SPADs based time-of-flight (ToF) sensor (100) that accurately measures distance by adequate, suitable, and efficient elimination of background light as claimed in claim 1, wherein the timing processing circuitry unit (113) eliminates crosstalk among plurality of signals through coordination between timing of correlated time signals and signal processing.

13. The SPADs based time-of-flight (ToF) sensor (100) that accurately measures distance by adequate, suitable, and efficient elimination of background light as claimed in claim 1, wherein the memory element unit (115) receives and stores cross-talk free signals from timing processing circuitry unit (113).

14. A method for accurate measurement of distance by adequate, suitable, and efficient elimination of background light by SPADs based time-of-flight (ToF) sensor (100):
detecting a plurality of photons when a pre-determined frequency of light falls for a defined amount of time onto a N×N SPAD photodetectors unit (101);
quenching and recharging N×N SPAD photodetectors unit (101) by utilizing front-end unit (103) when avalanche current/photons are provided as an input to the front-end unit (103) from the N×N SPAD photodetectors unit (101);
providing a defined shape to the signal/output provided by front-end unit (103) and generating a defined pulse width from pulse shape unit (105);
storing of pulse width as obtained via pulse store unit (107), wherein such pulse storing operation is performed by pulse store unit (107);
detection of peak into pulse width signal, wherein detection is performed via a peak detection unit (109);
providing peak detected signal as well as stored pulse width signal from peak detection unit (109) and pulse store unit (107) respectively to the digital logic unit (111);
receiving logical-based output provided by digital logic unit (11) into the timing processing circuitry (113); and
storing signal as obtained in memory elements units (115) from timing processing circuitry (113).

15. The method for accurate measurement of distance by adequate, suitable, and efficient elimination of background light by SPADs based time-of-flight (ToF) sensor (100) as claimed in claim 14, wherein a single photon is also detected through coincidence detection.

16. The method for accurate measurement of distance by adequate, suitable, and efficient elimination of background light by single photon avalanche diodes (SPADs) based time-of-flight (ToF) sensor (100) as claimed in claim 14, wherein the generated defined pulse width is adaptable to or supported by other units such as pulse store unit (107), peak detection unit (109), digital logic unit (111), timing processing circuitry (113), and memory elements unit (115).

17. The method for accurate measurement of distance by adequate, suitable, and efficient elimination of background light by SPADs based time-of-flight (ToF) sensor (100) as claimed in claim 14, wherein the peak detection unit (109) provides defined peak to the pulse width signal only when Vsense is greater than Vthreshold [Vsense>Vthreshold].

18. The method for accurate measurement of distance by adequate, suitable, and efficient elimination of background light by SPADs based time-of-flight (ToF) sensor (100) as claimed in claim 14, wherein correlated time-based signal is tracked when [Vsense>Vthreshold].

19. The method for background light removal/elimination in SPAD based time-of-flight (ToF) sensor as claimed in claim 14, wherein the digital logic unit (111) utilizes plurality of different combination of logical gates such that only correlated time-based signal is processed through single photon avalanche diodes (SPADs) based time-of-flight (ToF) sensor (100).

20. The method for background light removal/elimination in SPAD based time-of-flight (ToF) sensor as claimed in claim 14, wherein the timing processing circuitry unit (113) provides an analysis factor utilized by single photon avalanche diodes (SPADs) based time-of-flight (ToF) sensor (100) for analysis of signal characteristics to provide an adequate elimination of background light.

21. The method for background light removal/elimination in SPAD based time-of-flight (ToF) sensor as claimed in claim 14, wherein the accurate distance is measured between an object and a target from analysis of resultant image as provided by timing processing circuitry unit (113) in the presence of high background light and different target reflectivity.
